(19) United States
(12) Patent Application Publication
(10) Pub. No.: US 2012/0036301 A1
(43) Pub. Date: Feb. 9, 2012

(54) PROCESSOR SUPPORT FOR FILLING MEMORY REGIONS

(76) Inventors: Eric R. Caspole, Menlo Park, CA (US); Laurent Morichetti, San Jose, CA (US)

(21) Appl. No.: 12/849,724

(22) Filed: Aug. 3, 2010

(51) Int. Cl. G06F 13/28; G06F 12/08; G06F 9/44

(52) U.S. Cl. 710/308; 719/328; 711/118; 711/E12.017

(57) ABSTRACT

Techniques are disclosed relating to distributing workloads between processors and/or processing elements. A computer system having at least first and second processing elements may cause a request to initialize one or more memory regions to be handled by the second processing element. Initialization may be accomplished by the second processing element directly accessing a memory that includes the specified memory region to be initialized. Thus, while the second processing element is causing the memory region to be initialized, the first processing element is free to perform other computational tasks. A cache associated with the first processing element may be undisturbed as a result of the second processing element performing the initialization, which may avoid displacement of data from the cache.

### BACKGROUND

1. Technical Field

This disclosure relates to computer processors, and, more specifically, to processors that receive requests to fill memory regions.

2. Description of the Related Art

During operation of a computer, regions of memory may need to be initialized (filled) with certain values. Initializing a memory region takes certain computational resources—for example, a processor performing the initialization may have to write values into a series of memory locations, which can be time consuming. During such an initialization, the processor may be unable to perform other computing tasks.

Further, memory initialization operations may be disruptive to a cache associated with the processor. Cache performance may be negatively impacted by the processor as cache contents are displaced during memory initialization. For example, it is possible that some or all of the pre-existing contents of the cache (before initialization of the memory region began) will be replaced by contents of the memory region being initialized. Such replacement may slow program execution as other memory may be subsequently accessed to retrieve data that was formerly present in the cache.

### SUMMARY OF THE EMBODIMENTS

Various embodiments of methods and structures that allow a computer system or computing device to distribute certain memory operations from a first processing element to a second processing element are disclosed herein.

In one embodiment described, a computer readable medium is disclosed having program instructions stored thereon that are executable by at least a first processing element of a computing device to perform operations including receiving an indication of a memory region of the computing device to be initialized, and in response to said receiving, causing initialization of the memory region to be handled by a second processing element of the computing device. In a further embodiment, the indication is received from a control program being executed by the first processing element.

Another embodiment includes a method that comprises a first program receiving an indication of a memory region of a computing device to be initialized, wherein the first program is executing on a first processing element of the computing device, and in response to said receiving, the first program causing initialization of the memory region to be handled by a second processing element of the computing device. In a further embodiment, the second processing element uses direct memory access (DMA) to initialize the memory region without the first processing element directly accessing the memory region,

Yet another embodiment is a computer system that comprises a memory subsystem including a main memory, a secondary storage device, and at least first and second processing elements, wherein the secondary storage device has program instructions stored thereon that are executable by the first processing element to cause the computer system to receive an indication of a memory region to be initialized, wherein the memory region is in the main memory, and in response to said receiving, cause initialization of the memory region to be handled by the second processing element of the computing device. In a further embodiment, the computer system comprises a cache associated with the first processing element, wherein the cache is configured to store contents of the main memory in response to the first processing element accessing the main memory, and wherein causing initialization of the memory region does not result in the cache storing post-initialization contents of the memory region.

### BRIEF DESCRIPTION OF THE DRAWINGS

FIG. 1 is a block diagram illustrating one embodiment of a computer system configured to distribute memory initialization from a first processing element to a second processing element is depicted

FIGS. 2A-2B are block diagrams depicting an exemplary memory region before and after initialization.

FIG. 3A is a block diagram illustrating an embodiment of a memory subsystem that includes a control program configured to perform memory initialization.

FIG. 3B is a block diagram illustrating an embodiment of a memory subsystem that includes an operating system configured to perform memory initialization.

FIG. 3C is a block diagram illustrating an embodiment that includes a JAVA Virtual Machine program configured to perform memory initialization.

FIG. 4 is a flow diagram illustrating one embodiment of a method in which a memory initialization is distributed from a first processing element to a second processing element.

FIG. 5 is a block diagram illustrating another embodiment of a computer system in which a memory initialization is distributed from a first processing element to a second processing element.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising” or “Including.” These terms are open-ended. As used in the appended claims, these terms do not foreclose additional structure or steps. Consider a claim that recites: “An apparatus comprising one or more processing elements . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. Further, “configured to” may include adapting a manufacturing process (e.g., a semiconductor fabrication facility) to fabricate devices (e.g., integrated circuits) that are adapted to implement or perform one or more tasks.

“Processing Element.” This term has its ordinary and accepted meaning in the art, and includes a device (e.g., circuitry) or combination of devices that is capable of executing computer instructions. A processing element may, in various embodiments, refer to a single-core processor, a core of a multi-core processor, or a group of two or more cores of a multi-core processor.

“Processor.” This term has its ordinary and accepted meaning in the art, and includes a device that includes one or more processing elements. A processor may refer, without limitation, to a central processing unit (CPU), a co-processor, an arithmetic processing unit, a graphics processing unit, a digital signal processor (DSP), etc.

“First,” “Second,” etc. As used herein, these terms are used as labels for nouns that they precede, and do not imply any type of ordering (e.g., spatial, temporal, logical, etc.). For example, in a processor having eight processing elements or cores, the terms “first” and “second” processing elements can be used to refer to any two of the eight processing elements. In other words, the “first” and “second” processing elements are not limited to logical processing elements 0 and 1.

“Computer” or “Computer System.” This term has its ordinary and accepted meaning in the art, and includes one or more computing devices operating together and any software stored thereon. A computing device includes one or more processing elements and a memory subsystem. A memory subsystem may store program instructions executable by the one or more processing elements to perform various tasks.

“Computer-readable Medium.” As used herein, this term refers to a (nontransitory, tangible) medium that is readable by a computer or computer system, and includes magnetic, optical, and solid-state storage media such as hard drives, optical disks, DVDs, volatile or nonvolatile RAM devices, holographic storage, programmable memory, etc. The term “non-transitory” as applied to computer readable media herein is only intended to exclude from claim scope any subject matter that is deemed to be ineligible under 35 U.S.C. §101, such as transitory (intangible) media (e.g., carrier waves), and is not intended to exclude any subject matter otherwise considered to be statutory.

“Operating System.” This term has its ordinary and accepted meaning in the art, and includes a program or set of program that control access to resources of a computer system (e.g., in response to requests from applications). In some embodiments, an operating system controls access to I/O devices such as communication devices, storage devices, etc. As described herein, an operating system may, in certain embodiments, include instructions executable to cause a second processing element to perform memory initialization.

“Cache.” This term has its ordinary and accepted meaning in the art, and includes memory or other storage that stores data and may improve future requests for such data by providing faster access relative to some other memory or storage.

“Causing a Computer System to Perform Operations.” The execution of program instructions may be described or claimed as “causing a computer system to perform operations.” The phrase is to be interpreted broadly, covering instructions that, when executed, perform the operations in questions, as well as instructions that install or instantiate code that, when executed, performs the operations. For example, a computer readable medium may include instructions that are executable to cause the computer system to distribute memory initialization of a memory region from a first processing element of the computer system to a second processing element of the computer system.

“Executable.” This term has its ordinary and accepted meaning in the art, and includes instructions in a format associated with one or more particular processing elements (i.e., a certain instruction set architecture (ISA)), but also instructions that are in an intermediate format (e.g., JAVA bytecode) that can be interpreted by a control program (e.g., the JAVA virtual machine) to produce instructions for an ISA of a processing element. In accordance with this definition, a program that is “being executed” on a first processing element is having at least some of its instructions executed by that first element (though other instructions of that program may be executed by another element). Execution of a program also includes interpretation of a program.

“Application Programming Interface (API).” This term has its ordinary and accepted meaning in the art, and includes an interface that enables software to interact with other software. A program may make an API call to use functionality of an application, library routine, operating system, etc.

As described herein, a computer program may have a need to initialize (fill) computer memory with certain data, thereby erasing the data previously stored by that memory. In some embodiments, the need to initialize memory may occur in accordance with a request to receive an allocation of (new) memory. In one embodiment, a JAVA virtual machine (JVM) program (used to run other JAVA programs) may “zero out” memory regions so that JAVA programs can start using these memory regions with blank (default) data. In another embodiment, an operating system might overwrite memory with all zeros, for example, before allowing a user program to access that memory. (In some embodiments, the data that was erased could have held a password, a credit card number, or other data that the operating system does not wish a user program to be able to access.) Many other kinds of memory initialization by other types of programs are contemplated as well, and this disclosure is not limited to JVM or operating system software. The data that is filled into a memory region during initialization may, but need not be, all zeros, as described further below.

In one embodiment, a computer system has a first processor, such as a central processing unit (CPU), that is configured to execute, e.g., general-purpose instructions. The computer system also has a second processor, such as a graphic processing unit (GPU), which is configured to execute special-purpose instructions, such as graphics instructions. In other embodiments the first processor (or processing element) may include functionality of both a CPU and a GPU in a single device, package or integrated circuit. The computer system also has a memory subsystem. In an embodiment, the computer system is structured (i.e., programmed) such that certain instruction sequences are performed by the second processor. These instruction sequences may be generated by instructions executed by the first processor and can include memory initialization routines. Accordingly, the first processor may be freed to perform other tasks while the second processor performs initialization. (For example, the memory region to be initialized may not be needed right away, so the first processor may be able to continue executing the program while the second processor is performing the memory initialization). In addition to improving the performance of the first processor, techniques disclosed herein may also improve performance of a data cache associated with the first processor, for example, by avoiding displacement of data from the cache.

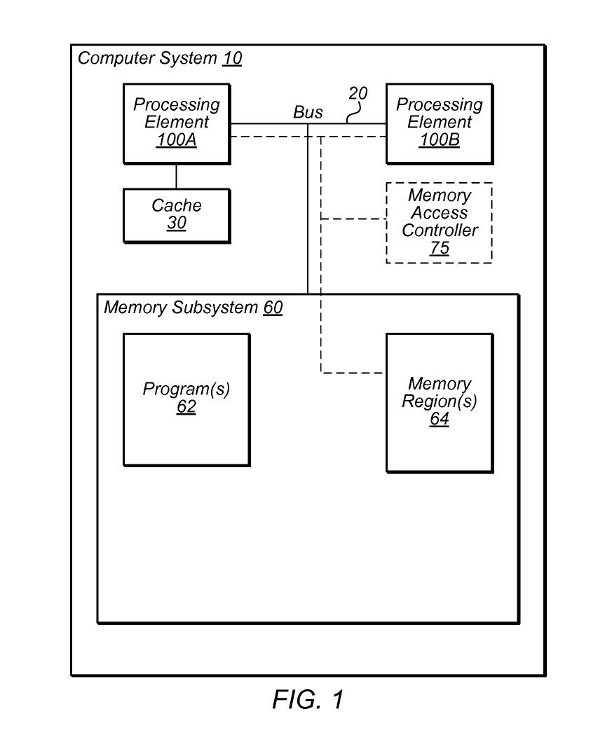

Turning now to FIG. 1, one embodiment of a computer system 10 configured to distribute memory initialization from a first processing element to a second processing element is depicted. Computer system 10 includes a first processing element 100A and a second processing element 100B linked by a bus 20. In one embodiment, bus 20 allows processing elements 100A and 100B to access one or more memory regions 64 within a memory subsystem 60. Memory subsystem 60 may contain various programs 62, some of which are executable to request (or to cause) memory be initialized using processing element 100B. Additionally, although shown as a visually distinct component in FIG. 1, a portion or all of memory subsystem 60 may form part of circuitry of processing element 100A, processing element 100B, or be a part of a single device which includes both processing elements 100A and 100B. In one embodiment, a cache 30 is accessible to processing element 100A, and is configured to store data corresponding to data stored in memory subsystem 60. In one embodiment, a memory access controller 75 may be coupled to (or implemented within) any combination of processing element 100A, 100B, memory subsystem 60, and may be coupled to bus 20. Computer system 10 may be configured differently in various embodiments.

Processing elements 100A and 100B may correspond to (or be located within) any type of processor (e.g., central processing unit, arithmetic processing unit, graphics processing unit, digital signal processing unit, etc.). In one embodiment, processing element 100A is a central processing unit (or group of one or more cores) and processing element 100B is a different type of processing unit, e.g., a graphics processing unit (that may have one or more cores). In some embodiments, one or both of processing element 100A and 100B may include multiple cores. In other embodiments, processing elements 100A and 100B may be different groups of one or more processor cores located on the same chip. Processing elements 100A and 100B may, in some embodiments, comprise a cluster or group of various processing elements (for example, element 100A could be a group of two quad-core processors).

In one embodiment, bus 20 coupling the processing elements to memory subsystem 60 may be a Northbridge bus, or any other processor bus or processor interconnect known to those of skill in the art. Bus 20 is an interconnect, in one embodiment, between (groups of one or more) processor cores, which may be located on the same chip. Bus 20 need not be limited to a single bus or interconnect, however, and may be any combination of one or more busses, (point to point) interconnects, or other communication pathways and devices suitable to convey data to the structures described herein.

Memory subsystem 60 includes one or more memory devices. In various embodiments, these memory devices may comprise RAM modules, embedded memory (e.g., eDRAM), solid state storage devices, secondary storage devices such as hard drives, or any other computer-readable medium as that term is defined herein. In one embodiment, memory subsystem 60 includes one or more memory regions 64 within the one or more memory devices of memory subsystem 60. A memory region 64 is not necessarily of fixed size or location, but may instead refer to one or more portions of memory having arbitrary beginning and end locations (or addresses). Thus, in one specific embodiment, a first memory region might be a series of memory locations that is 4000 KB in size while a second memory region is a series of memory locations that is 32 KB in size. In one embodiment, a memory region 64 may span multiple memory devices (or even span types of memory device; for example, a single memory region could include storage space on a RAM module and a hard drive). A memory region may or may not be physically or logically contiguous.

Memory subsystem 60 and its memory regions are accessible by processing element 100A. For example, processing element 100A may retrieve data from (and store data in) memory subsystem 60 via bus 20. In various embodiments, as described herein and below, memory subsystem 60 is also accessible by processing element 100B. In various embodiments, memory subsystem 60 stores one or more programs 62. Program(s) 62 may be any program(s) executable on computer system 10. Thus, in various embodiments, program 62 may be a JVM, an operating system, an API library, a user program running on the JVM or operating system, etc. In various embodiments, a program 62 may have the ability to distribute memory initialization from processing element 100A to 100B, as further described herein.

Memory access controller 75 is coupled to memory subsystem 60 in one embodiment, and is configured to control, manage, coordinate, and/or allow memory access by processing elements 100 to memory subsystem 60 in various embodiments. Memory access controller 75 is a direct memory access (DMA) controller in one embodiment, and may be located on a same chip with processing elements 100A and/or 100B. In various embodiments, memory access controller 75 may restrict processing element 100B from accessing memory regions 64 unless alerted, notified, or granted permission by processing element 100A—in which case access controller 75 may allow access to some (or all) regions of memory subsystem 60. Memory access controller 75 may be configured to use (and/or couple to) bus 20 in one embodiment.

Cache 30 is accessible by processing element 100A, and comprises a cache configured to hold data corresponding to memory subsystem 60. Cache 30 may thus be configured to hold a subset of data stored in memory subsystem 60 in order to provide faster access to that data to processing element 100A. In various embodiments, cache 30 may comprise a hierarchical cache system, including L1, L2, L3, or other caches. Cache 30 may be partially or wholly located within processing element 100A, or may be partially or wholly located outside of processing element 100A in various embodiments (for example, in one embodiment, cache 30 comprises an L1 cache that is within processing element 100A, and an L2 cache that is outside of element 100A). A cache that is “associated” with a given processing element is configured to be accessed by that processing element.

In some instances, caching operations will cause data previously stored in cache 30 to be replaced with (or displaced by) other data. In some embodiments, when processing element 100A directly accesses a memory region of memory subsystem 60, a portion of cache 30 will be used to store accessed data. For example, if processing element 100A were to directly access memory subsystem 60 to initialize a memory region 64, pre-existing data in cache 30 might be displaced by newly initialized data for that memory region. Data displaced from a cache may take longer to access, which can result in longer execution times. For example, consider the following C code:

int C=A+B;

int*Freespace=malloc (8192);

E=C;

This code (when compiled and executed) might first result in a data value for variable “C” being cached. A call to malloc( ) might then cause 8192 bytes of memory to be initialized, displacing the value for “C” from cache. Upon the next instruction being executed (which assigns the value of “C” to variable E), the cache might encounter a “miss,” and thus have to retrieve variable C's value from a lower level of cache or more distant memory, resulting in a delay. If C's value had never been displaced from the cache in the first place, this delay could have been avoided, possibly speeding performance. Data displacement/replacement for cache 30 may be governed in various embodiments by replacement policies that include any number of hardware or software schemes that would occur to those of skill in the art, including least recently used (LRU) replacement.

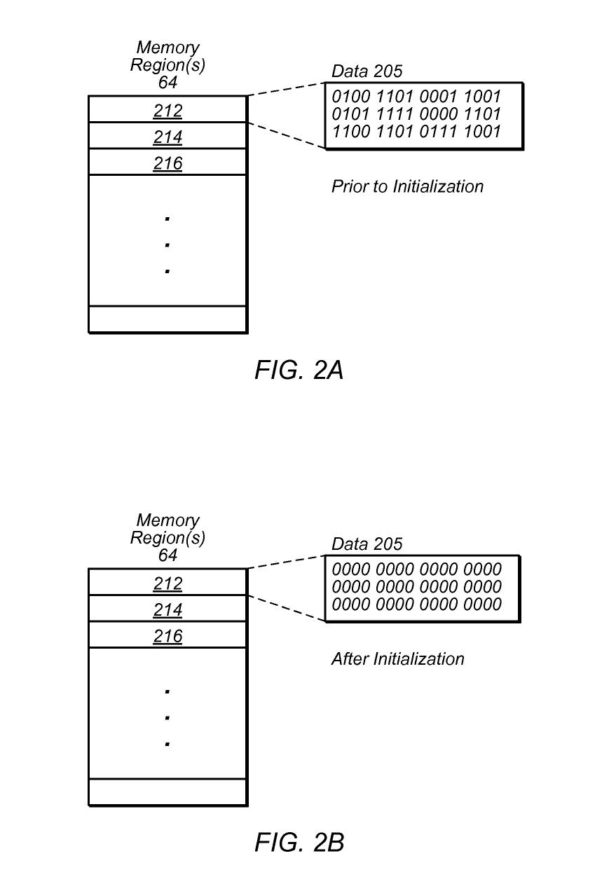

Turning now to FIG. 2A, an example of a memory region 64 prior to initialization is shown. As depicted, memory region 64 includes a plurality of memory locations (including locations 212-216), each of which may be individually addressable and configured to store a given amount of data in various embodiments. As shown, memory location 212 is storing data 205. Data 205 in memory location 212 may have been written previously by a program being executed by computer system 10 in some embodiments, or may simply be arbitrary (random).

In FIG. 2B, an example of memory region 64 after initialization is shown. In this embodiment, the data 205 in memory location 212 has been “zeroed out” by initializing it to a sequence of bits having values of zero. As discussed further herein, this initialization may be performed in certain embodiments by processing element 100B. “Zeroing out” is only one form of initialization; other initialization may include writing data in a test pattern (e.g., values corresponding to all negative ones, the hex value 0xDEADBEEF, etc.). Initialization may be performed, in some embodiments, in accordance with an external specification, such as the JAVA programming language specification. Initialization is not limited to the data types and values described above and may, in various embodiments, include any data that fills one or more memory regions.

In some embodiments, memory initialization may be limited to initializing memory regions of a certain minimum size (possibly at the discretion of a control program that services requests for initialization). For example, memory initialization could be limited to initializing areas of memory no smaller than a page (as defined by an operating system of computer system 10—for example, a page of 8 KB), or the width of a cache line, or a given fixed size (such as 1024 bytes), etc. In these embodiments, a minimum size threshold for memory initialization might be enacted to avoid possible performance penalties involved by using a second processing element to initialize a small memory region, as using a second processing element rather than a first processing element to perform initialization may involve certain unavoidable overhead costs in various embodiments.

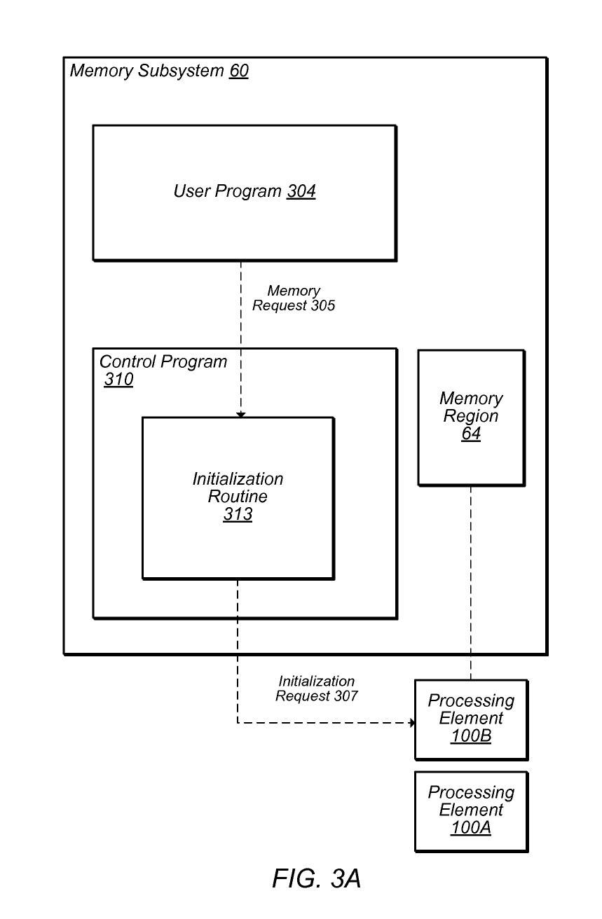

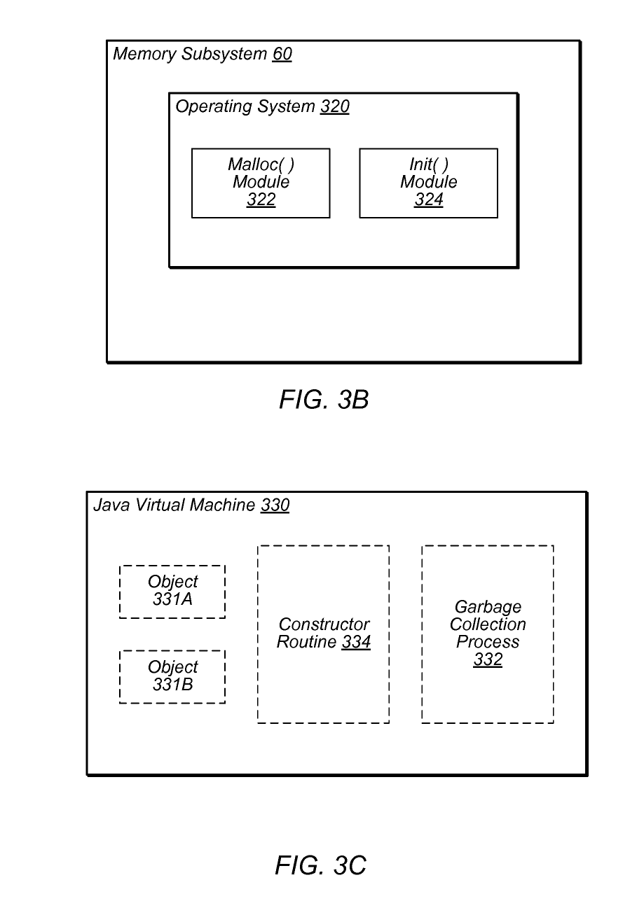

Turning now to FIG. 3A, a block diagram is shown illustrating an embodiment that includes a user program 304 and a control program 310 within memory subsystem 60. In one embodiment, programs 304 and 310 are both respective programs 62 as described above with respect to FIG. 1. In various embodiments, user program 304 may lack privileges (or may not be programmed and/or designed) to directly access memory and initialize memory region(s), while control program 310 is executable to initialize memory regions (e.g., using initialization routine 313). For example program 304 may be a JAVA process and/or user application, while program 310 may be a JVM or an operating system; see discussion of FIGS. 3B-3C below). In various embodiments, user program 304 and control program 310 are stored within one or more memory devices in subsystem 60 (for example, control program 310 may be stored on a hard drive, and also be loaded (wholly or partially) into a RAM module during execution).

Control program 310 includes instructions, in various embodiments, that are executable by processing element 100A and/or processing element 100B—that is, a given control program 310 may include instructions executable by processing element 100A, processing element 100B, or some combination of 100A and 100B. For example, in one embodiment, control program 310 includes instructions in a single instruction set architecture (ISA) executable by both 100A and 100B, while in another embodiment, control program 310 includes instructions that are in a first ISA executable by processing element 100A and also includes instructions in a second, different ISA that is executable by processing element 100B. Memory initialization routine 313 may thus include instructions in a different ISA than other portions of control program 310 in some embodiments.

In one embodiment, control program 310 includes a set of program instructions comprising initialization routine 313, which is executable to receive a memory request 305 from user program 304. (In another embodiment, control program 310 generates a memory request 305 internally.) Memory initialization routine 313 is executable to cause processing element 100B (rather than element 100A) to initialize one or more memory regions 64 that may be specified by initialization request 305. Memory initialization routine 313 may comprise instructions, in various embodiments, that correspond to code that is written in a programming language such as OPENCL, JAVA, C++, etc. The code corresponding to routine 313 may be interpreted and/or compiled in order to perform the initialization routine 313 in various embodiments.

An example of how OPENCL code may be used to generate instructions executable by processing element 100B can be found in U.S. application Ser. No. 12/785,052, entitled “DISTRIBUTING WORKLOADS IN A COMPUTING PLATFORM,” filed May 21, 2010, which is incorporated herein by reference.

Memory initialization routine 313 may be executed, in various embodiments, to cause processing element 100B to initialize memory region 64. In one embodiment, execution of initialization routine 313 begins in response to initialization request 305, which may be generated by user program 304. Initialization request 305 may take various forms in various embodiments, and includes information usable to identify or determine one or more memory regions 64 to be initialized. In one embodiment, request 305 specifies a name of a data object. In one embodiment, initialization request 305 includes a memory base address and an offset value (length) of memory space to be initialized. In other embodiments, initialization request 305 includes a memory base “start” address and a memory ceiling “stop” address to be initialized. Memory request 305 is not thus limited, however, and may include any information usable to determine one or more memory regions 64 to be initialized.

During execution, control program 310 is executed by processing elements 100A and/or 100B, but in at least one embodiment, execution of initialization routine 313 is performed solely by processing element 100B by means of initialization request 307. The execution of routine 313 by element 100B may proceed in different manners in various embodiments. In one embodiment, portions of control program 310 may be executable by element 100A to “set up” execution of routine 313 by element 100B. Processing element 100A may send a control message, notification, or instruction to processing element 100B that includes a reference to routine 313. Upon receiving such a control message, processing element 100B could then proceed to execute routine 313 (e.g., by directly accessing memory, and/or a cache, in which the instructions of routine 313 are stored). In another embodiment, the instructions for initialization routine 313 might simply be put out onto a bus (such as bus 20), at which time processing element 100B would recognize and execute the instructions. In one embodiment, element 100A may execute instructions (in an ISA of element 100A) to perform one or more configuration operations for element 100B, including configuration operations that cause memory access controller 75 to give processing element 100B direct access to memory region 64. Various other techniques are also usable to cause processing element 100B to execute initialization routine 313, as will occur to those skilled in the art.

The instructions of initialization routine 313 contain, in one embodiment, one or more references to one or more memory regions 64 to be initialized, as well as instructions executable by processing element 100B to cause the one or more memory regions to be initialized. The data that fills initialized memory regions can be all zeros, all negative ones, patterned data, or any other data, as noted above. In some embodiments, portions of (or the entirety of) initialization routine 313 may be dynamically generated by control program 310. Dynamic generation may occur in response to information in memory request 305 in one embodiment. For example, if memory request 305 specifies that an 8 MB portion of RAM is to be initialized, at least a portion of initialization routine 313 may be dynamically modified to reflect this 8 MB value.

Initialization routine 313 may be performed as part of various software programs—for example, in one embodiment, routine 313 may be performed as part of a library routine, with request 305 being made according to the specifications of an application programming interface (API). In another embodiment, routine 313 may be performed as part of a JAVA garbage collection process (as described below further with reference to FIG. 3C). Initialization routine 313 is not limited to the types of programs described above, however.

Turning now to FIG. 3B, a block diagram is shown depicting an embodiment in which an operating system 320 of computer system 10 is configured to distribute memory initialization from a first processing element to a second processing element. In one embodiment, operating system 320 may operate wholly or in part to perform any and all of the operations described above with respect to control program 310. In various embodiments, operating system 320 may receive, generate, and/or handle one or more requests 305 to initialize one or more memory regions 64. In one embodiment, request 305 may be received by libraries (or modules) within operating system 320, which may be callable by a program such as program 62, program 304, or even operating system 320 itself. These libraries may be stored, in various embodiments, as one or more files in memory subsystem 60, and may include API interfaces for modules such as 322 and 324, which correspond to the C programming language functions malloc( ) and init( ) For example, a program 62 running on computer system 10 may request to have (more) memory allocated to it by calling the malloc( ) routine. The operating system 320 may accordingly service that request, in one embodiment, by loading and/or dynamically generating suitable instructions (such as initialization routine 313), and then causing those loaded or generated instructions to be executed by the second processing element 100B. Such an initialization may be desirable for security reasons, in order to avoid freshly allocated memory blocks leaking data from one program to another, for example. Init module 324 may be used to load another process into memory in one embodiment, and thus might internally generate a request for memory 305 (which in turn may cause an initialization request 307 to be sent to processing element 100B).

Turning now to FIG. 3C, a block diagram is shown depicting an embodiment in which a JAVA Virtual Machine (JVM) 330 is configured to cause memory initialization to be distributed from a first processing element to a second processing element. JVM 330 may operate wholly or in part to perform any and all of the operations described above with respect to control program 310, and may be stored in memory subsystem 60 (not depicted). In one embodiment, JVM 330 is configured to execute JAVA bytecode of one or more JAVA programs stored in memory subsystem 60 (accordingly, control program 310 may thus execute other programs, and is furthermore not limited to JAVA programs in this respect). Execution of JAVA bytecode may cause any number of JAVA objects 331 to be instantiated and/or destroyed. Default initial values for JAVA objects may be set to all zeros in various embodiments of JVM 330. Such initialization may be performed, in various embodiments, by garbage collection process 332 and/or constructor routine 334 (which may, in some embodiments, and in whole or in part, correspond to initialization routine 313). As the last step of garbage collection process 332, in one embodiment, all of one or more memory regions may be made available for future object allocation by zeroing the memory regions out (thus ensuring a store of already-initialized memory until a next garbage collection results in additional initialized memory). Or the zeroing can be done, in various embodiments, on a one-at-a-time basis as new objects get allocated by JAVA user programs.

In one embodiment, garbage collection process 332 determines what JAVA objects are no longer being used and de-allocates memory for those unused objects. In the process of de-allocating this memory, JVM 330 may initialize one or more corresponding memory regions to contain values of zero. JVM 330 may also cause one or more constructor routine(s) 334 to be run. Constructor routine(s) 334 may be default routines, and may require the allocation of free memory to be made to one or more JAVA programs running on JVM 330, and may likewise cause the initialization of one or more memory regions 64 during execution of those JAVA programs (which may correspond to user program 304 in various embodiments). Various techniques and permutations for optimizing the initialization of memory regions by JVM 330 will occur to those with skill in the art. For example, JVM 330 might be configured to “zero” a larger amount of memory (e.g., 1 MB) and parcel that memory out as needed to satisfy the demands of newly created JAVA objects (rather than initializing memory every single time a class is instantiated).

In various embodiments, numerous programs other than operating system 320 and JVM 330 may cause computer system 10 to distribute the task of initializing memory regions from processing element 100A to processing element 100B. Different programming languages designed to be compiled and executed (or interpreted) by processing elements of computer system 10 may have libraries that include API routines designed to take advantage of memory initialization distribution (or offloading) capabilities. Further, a compiler could be designed to cause distribution of memory initialization using techniques described herein when generating executable code from high level source code. The compiler could employ heuristics, in one embodiment, to determine when it would benefit program performs to distribute one or more memory fill operations from a first processing element to a second (for example, factors that could form the basis for such heuristics could include the size of a memory region (perhaps offloading/distributing when the region was sufficiently large), how often and how soon the memory region is to be accessed following initialization, the number of bytes of the initialized region to be accessed in a given period following initialization being performed, the quantity of cache misses anticipated as a result of cache displacement from not offloading a given memory initialization, etc.). In some embodiments, the memory initialization techniques described herein are transparent to a source code programmer in some cases—for example, a source code programmer might program a call in the C programming language to malloc( ) according to the specifications of that programming language without ever knowing that a library routine that handles that call will cause initialization of memory to be distributed from a first element to a second element.

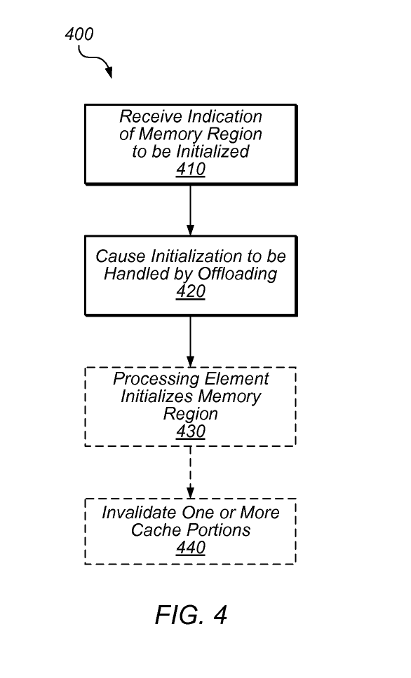

Turning now to FIG. 4, a flow diagram of one embodiment of a method 400 for to offloading initialization of one or more memory regions by a first processing element to a second processing element is shown. Method 400 may be performed, in whole or in part, by computer system 10 or any other suitable computer system or computing device such as system 500 described below. In step 410, an indication of one or more memory regions to be initialized is received. This step may be performed, in one embodiment, by processing element 100A executing control program 310 to receive a request for memory, e.g., from program 304. In one embodiment, step 410 includes receiving a request generated by a garbage collection process, such as process 332 of JVM 330.

In step 420, in response to receiving the indication of step 410, computer system 10 causes initialization of the requested memory region to be offloaded from processing element 100A to processing element 100B. In one embodiment, step 420 is performed by processing element 100A and causes initialization of the requested memory region to be offloaded to processing element 100B. Step 420 may also include, in various embodiments, processing element 100A performing configuration operations or otherwise interacting with processing element 100B in a manner that causes processing element 100B to initialize memory region 64 (e.g., setting up element 100B to execute an initialization routine 313).

In step 430, the processing element to which the initialization request of step 410 has been offloaded (i.e., distributed) initializes the indicated one or more memory regions. In one embodiment, this step is performed by processing element 100B using direct memory access (via controller 75) to initialize the requested memory region. Thus in various embodiments of step 430, initialization is performed without processing element 100A directly altering values for the memory region to be initialized. In certain embodiments, step 430 is performed according to one or more predetermined rules, routines, etc., of control program 310. These rules could include heuristics (e.g., heuristics as described above.)

In step 440, one or more portions of a cache of computer system 10 may be invalidated. In a system with multiple processing elements (such as computer system 10), a copy of the data in memory region 64 may be stored in the memory hierarchy (including cache 30) in some embodiments. If memory region 64 is initialized according to method 400, it may be necessary in some instances and in some embodiments to perform a cache invalidation procedure in order to make sure that there are no stale copies of data corresponding to initialized memory region 64 that remain in a cache of computer system 10 (e.g., cache 30). Step 440 may be initiated variously by processing element 100A, processing element 100B, and/or memory access controller 75 in various embodiments, and may be performed using various techniques known to those of skill in the art.

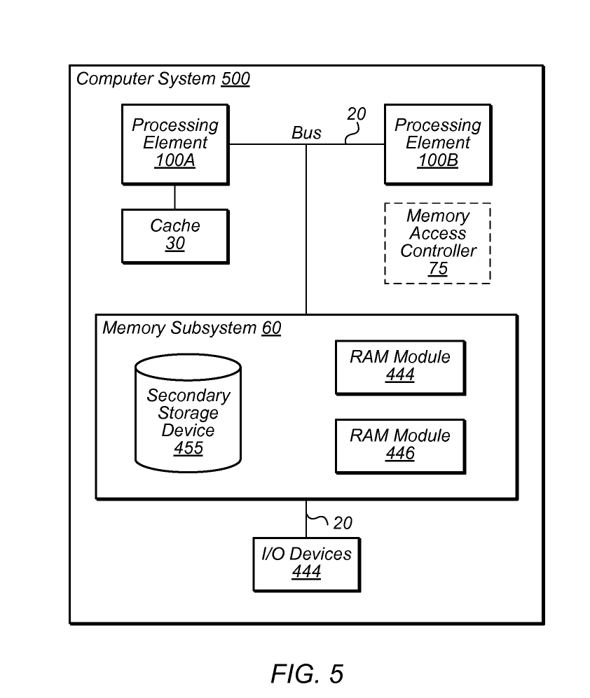

Turning now to FIG. 5, a block diagram is shown depicting an exemplary computer system 500 capable of implementing various embodiments described above. Components of computer system 500 may be identical or similar to components of computer system 10, in whole or in part. For example, computer system 500 as depicted includes a memory subsystem 60, processing elements 100A and 100B, cache 30, and memory access controller 75. Computer system 500 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 500 may also be any type of networked peripheral device such as storage devices, switches, modems, routers, etc. Although a single computer system 500 is shown in FIG. 5 for convenience, system 500 may also be implemented as two or more computer systems operating together.

In one embodiment of computer system 500, memory subsystem 60 includes a secondary storage device 455 and RAM modules 444 and 446. In one embodiment, secondary storage device 455 has program instructions stored thereon that are executable by first processing element 100A to cause the computer system to receive an indication of a memory region to be initialized, wherein the memory region is in the memory of the computer system, and in response to said receiving an indication, causing initialization of the memory region to be handled by second processing element 100B of the computing device. Processing elements 100A and 100B may be heterogeneous (i.e., of differing types) in certain embodiments—for example where element 100A is a central processing unit (CPU) and 100B is a graphics processing unit (GPU). Further, in one embodiment, cache 30 may be configured to store contents of one or more memory devices in memory subsystem 60 in response to processing element 100A accessing the memory, wherein causing the initialization of a memory region does not include causing the cache to store post-initialization contents of that memory region (i.e., cache 30 may avoiding displacement of other data within cache 30 by freshly initialized data corresponding to an initialized memory region). Memory access controller 75 may be configured to provide processing element 100B direct access to one or more memory devices in memory subsystem 60 in various embodiments, wherein causing initialization of a memory region includes processing element 100B accessing the memory region using memory access controller 75, and wherein causing initialization does not include processing element 100A accessing (i.e., altering) the memory region.

Additionally, in one embodiment, I/O devices 444 are coupled to memory subsystem 60 via a bus 20. In various embodiments, I/O devices may include other storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device. I/O devices may include interfaces of various types, which may be configured to couple to and communicate with other devices and their interfaces, according to various embodiments. In one embodiment, an I/O interface is a bridge chip (e.g., Southbridge) from a front-side to one or more back-side buses.

Memory subsystem 60 includes memory usable by processing elements 100A and/or 100B in various embodiments. Memory in subsystem 60 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 500 is not limited to storage such as RAM 444 and 446 and secondary storage 455; rather, computer system 500 may also include other forms of storage such as cache memories not depicted, and secondary storage on I/O Devices 444 (e.g., a hard drive, storage array, etc.). In some embodiments, these other forms of storage may also store program instructions executable by processing elements 100A and/or 100B.

The above-described techniques and methods may be implemented as computer-readable instructions stored on any suitable computer-readable medium. These instructions may be software that allows a computer system and/or computing device to operate in manners described above, and may be stored in a computer readable medium within memory subsystem 60 (or on another computer readable medium that is not within memory subsystem 60). Library routines, garbage collection processes, other software routines and objects, and any or all of software 62, 304, 310, 313, 320, 322, 324, 330, 331, 332, 334 may thus be stored on such computer readable media. (As noted above in paragraph 23, such media may be non-transitory.)

Further, the above-described techniques and methods may be implemented in hardware in some embodiments. For example, one embodiment is a processing element that includes memory initialization circuitry configured to cause initialization of a memory region of a memory device to be handled by a second processing element, wherein causing initialization is performed in response to an indication that the memory region is to be initialized. Hardware embodiments may use circuit logic to implement algorithms and techniques described above (such as method 400, for example).

Hardware embodiments may be generated using hardware generation instructions. For example, the hardware generation instructions may outline one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of a processing element (such as 100A and/or 100B) that is configured to implement memory initialization distribution/offloading. The netlist may then be placed and routed to produce a data set describing geometric shapes to be applied to masks. The masks may then be used in various semiconductor fabrication steps to produce a semiconductor circuit or circuits corresponding to one or more processing elements (such as 100A and/or 100B). Alternatively, the database may be the netlist (with or without the synthesis library) or the data set, as desired. Thus, hardware generation instructions may be executed to cause processors and/or processing elements that implement the above-described methods and techniques to be generated or created according to techniques known to those with skill in the art of fabrication. Additionally, such hardware generation instructions may be stored on any suitable computer-readable media (which may be within a memory subsystem such as 60, or on other computer-readable media).

A computer-readable storage medium as described above can be used in some embodiments to store instructions read by a program and used, directly or indirectly, to fabricate the hardware comprising processing element 100A and/or 100B. For example, the instructions may outline one or more data structures describing a behavioral-level or register-transfer level (RTL) description of the hardware functionality in a high level design language (HDL) such as Verilog or VHDL. The description may be read by a synthesis tool, which may synthesize the description to produce a netlist. The netlist may comprise a set of gates (e.g., defined in a synthesis library), which represent the functionality of a processing element 100, a memory initialization unit, and/or memory initialization circuitry. The netlist may then be placed and routed to produce a data set describing geometric shapes to be applied to masks. The masks may then be used in various semiconductor fabrication steps to produce a semiconductor circuit or circuits corresponding to hardware embodiments. Alternatively, the database may be the netlist (with or without the synthesis library) or the data set, as desired. One embodiment is thus a (non-transitory) computer readable storage medium comprising a data structure which is usable by a program executable on a computer system to perform a portion of a process to fabricate an integrated circuit including circuitry described by the data structure, wherein the circuitry described in the data structure includes a memory initialization unit configured to cause initialization of a memory region of a memory device to be handled by a second processing element of a computing device rather than a first processing element of the computing device, wherein said causing initialization is performed in response to an indication that the memory region is to be initialized.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored thereon that are executable by at least a first processing element of a computing device to perform operations including:
responsive to an indication of a memory region of the computing device to be initialized, causing initialization of the memory region to be handled by a second processing element of the computing device.

2. The non-transitory computer readable medium of claim 1, wherein the indication of the memory region is received, from a first program, by a control program being executed by the first processing element.

3. The non-transitory computer readable medium of claim 2, wherein the control program is executing the first program.

4. The non-transitory computer readable medium of claim 2,
wherein the indication specifies one or more memory regions of memory corresponding to one or more data objects operable with the control program; and
wherein the operations further include filling all contents of the one or more memory regions.

5. The non-transitory computer readable medium of claim 4, wherein the operations further include:
the control program, as part of a garbage collection process, generating a plurality of indications of memory regions to be initialized; and
causing initialization of the plurality of memory regions to be handled by the second processing element, wherein the initialization includes filling all contents of the plurality of memory regions with default contents that are specified by a programming language specification.

6. The non-transitory computer readable medium of claim 2, wherein the control program includes one or more library files stored on the non-transitory computer readable medium, and wherein the control program receiving the indication includes the control program receiving the indication through an application programming interface (API).

7. The non-transitory computer readable medium of claim 1, wherein said causing initialization includes dynamically generating at least portions of a set of one or more instructions executable by the second processing element to alter contents of the memory region.

8. The non-transitory computer readable medium of claim 1, wherein causing initialization of the memory region to be handled by the second processing element does not cause a cache of the computer system to store post-initialization contents of the initialized memory region;
wherein the cache is configured, in response to the first processing element accessing a memory of the computer system that includes the memory region, to store contents of the memory region.

9. The non-transitory computer readable medium of claim 1, further comprising program instructions executable to cause generation of at least one of the first and second processing elements.

10. A method, comprising:
in response to an indication of a memory region to be initialized, a first program that is executing on a first processing element causing initialization of the memory region to be handled by a second processing element, wherein a computing device comprises the first and second processing elements and a memory including the memory region.

11. The method of claim 10, further comprising the second processing element using direct memory access (DMA) to initialize the memory region without the first processing element directly accessing the memory region.

12. The method of claim 10, further comprising a garbage collection process within the first program generating the indication.

13. The method of claim 10, wherein the first program is a control program, the method further comprising the second processing element initializing the memory region according to one or more heuristic rules of the control program.

14. The method of claim 10, further comprising:
in response to the memory region being initialized, the computing device invalidating one or more portions of a data cache of the computing device;
wherein the one or more invalidated portions correspond to contents of the memory region prior to initialization of the memory region.

15. A computer system, comprising:
a memory subsystem including main memory;
a secondary storage device; and
at least first and second processing elements;
wherein the secondary storage device has program instructions stored thereon that are executable by the first processing element to cause the computer system to:
in response to an indication of a memory region of the main memory to be initialized, cause initialization of the memory region to be handled by the second processing element.

16. The computer system of claim 15, wherein the first and second processing elements are heterogeneous.

17. The computer system of claim 15, further comprising:
a cache associated with the first processing element, wherein the cache is configured to store contents of the main memory in response to the first processing element accessing the main memory; and
wherein said causing initialization of the memory region does not result in the cache storing post-initialization contents of the memory region.

18. The computer system of claim 15, further comprising:
a memory access controller configured to provide the second processing element direct access to the main memory;
wherein causing initialization of the memory region includes the second processing element accessing the memory region using the memory access controller, and wherein causing initialization does not include the first processing element accessing the memory region.

19. A processing element, wherein the processing element includes memory initialization circuitry configured to cause initialization of a memory region of a memory device to be handled by a second processing element, wherein said causing initialization is performed in response to an indication that the memory region is to be initialized.

20. A non-transitory computer readable storage medium comprising a data structure which is usable by a program executable on a computer system to perform a portion of a process to fabricate an integrated circuit including circuitry described by the data structure, the circuitry described in the data structure including:
a memory initialization unit configured to cause initialization of a memory region of a memory device to be handled by a second processing element of a computing device rather than a first processing element of the computing device, wherein said causing initialization is performed in response to an indication that the memory region is to be initialized.

21. The non-transitory computer readable storage medium of claim 20, wherein the storage medium stores at least one of HDL, Verilog, or GDSII data.
